(19) United States
(12) Patent Application Publication
(10) Pub. No.: US 2026/0188334 A1
(43) Pub. Date: Jul. 2, 2026

(54) ADAPTIVE ENCODING OF TRANSIENT AUDIO SIGNALS

(71) Applicant: Telefonaktiebolaget LM Ericsson (publ), Stockholm (SE)

(72) Inventors: Charles KINUTHIA, STOCKHOLM (SE); Jonas SVEDBERG, UPPSALA (SE); Tomas JANSSON TOFTGÅRD, UPPSALA (SE)

(21) Appl. No.: 19/130,303

(22) PCT Filed: Nov. 22, 2023
(86) PCT No.: PCT/EP2023/082765

§ 371 Date: May 15, 2025

Related U.S. Application Data
(60) Provisional application No. 63/427,503, filed on Nov. 23, 2022.

(51) Int. Cl. G10L 19/025

(52) U.S. Cl. CPC G10L 19/025

(57) ABSTRACT

A method and an encoder to adjust a coding scheme selection when detecting a transient in an input sound signal. The encoder encodes the input signal in frames using a frequency-domain, FD, coding scheme or time-domain, TD, coding scheme. The method comprises detecting one or more of a transient attack and a transient release in the input signal and a location of the one or more of the transient attack and the transient release in at least one of a current frame and a previous frame. Based on a plurality of conditions associated with the one or more of the transient attack and the transient release it is determined whether or not to force a TD coding scheme, and selecting the TD coding scheme responsive to determining that the TD coding scheme is forced to be used.

### TECHNICAL FIELD

The present disclosure relates generally to communications, and more particularly to encoding and decoding of transient audio signals and related devices and nodes supporting encoding and decoding.

### BACKGROUND

Modern audio codecs like 3GPP-EVS (3rd Generation Partnership Project—Enhanced Voice Services) and MPEG-USAC (moving pictures expert group—unified speech and audio coding) consist of multiple compression schemes optimized for signals with different properties. Typically, speech-like signals are processed with time-domain (TD) coding schemes, e.g., using ACELP (algebraic code excited linear prediction), while music signals are processed with frequency-domain (FD) coding schemes, e.g., based on the Modified Discrete Cosine Transform (MDCT). In the following description, terms a compression scheme, a coding scheme and an encoding scheme are used interchangeably.

For FD encoding schemes, transform windows having different lengths and tapering at the beginning and end of the window, for example as shown in FIG. 1, can be used. The windows may also be zero padded before transformation. Operating at low bitrates, the FD encoding scheme is typically restricted to use a wide (or long) transform block in order to save bits. In a transition coding scheme, switching from TD to FD coding, the MDCT transform length may temporarily be increased to catch up with the regular MDCT framing and thus the bitrate/sample is reduced. For the EVS codec 25 ms is synthesized by the FD transition coding mode instead of the 20 ms synthesis in a regular TCX20 frame, giving a 25% reduction of bitrate/sample.

To select the optimal compression scheme, audio codecs perform analysis on the input signal. The analysis typically includes a transient detector and a speech/music classifier. The input signal is divided into segments, referred to as frames, each frame is processed by the codec sequentially and put into a bitstream. A transient detector such as the one utilized by the EVS codec (3GPP TS 26.445 V16.1.1 (2020 December), “Codec for Enhanced Voice Services (EVS); Detailed Algorithmic Description”, Section 5.1.8) typically operates on a subframe level, that is, it divides the 20 ms frame into 8 non-overlapping subblocks of 2.5 ms. If there is a significant increase in energy in one of the subframes, an attack flag is set. This transient detector works as follows:
1. Given frame F_{N}, divide the frame into 8 subframes, denoted as Sᵢ[j], where j is the j^{th} sample in the i^{th} subframe. Negative indices for i denote the preceding subframes belonging to the previous frame.
2. Compute the energy of each subframe,

$${E}_{i} = {\sum }_{j = 0}^{k - 1} {{S}_{i} [ j ]}^{2} ,$$

where k is the number of samples in each subframe.
3. Compute a lowpass filtered max energy envelope for each subframe, accEᵢ.

```
If i == 0: initialize tmpE with the last subframe of the previous frame,
that is accE₋₁
for(i = 0; i < 8; i = i + 1)
{
  accEᵢ = tmpE
  tmpE = max (Eᵢ, α * tmpE)
}
where α is less than 1, e.g. 0.8125.
```

4. Detect if there is an attack in the main part of the windowed signal (i∈{−2,−1,0,1,2,3,4,5}) as shown in FIG. 1, by checking if the subframe energy is substantially above accE by a threshold θ, where θ can be 8.5.

```
for (i = −2: i < 6; i = i + 1)
{
  if Eᵢ > accEᵢ * θ
  {
    set attack flag
  }
}
```

For speech/music classification, several features are used. For example, the classifier used by EVS (GPP TS 26.445 V16.1.1 (2020 December), “Codec for Enhanced Voice Services (EVS); Detailed Algorithmic Description” Section: 5.1.13.6 Speech/Music Classification” (a.k.a. SMC Speech Music Classifier)) employs a two-stage speech/music classifier. The first stage uses features such as Line Spectral Frequencies (LSF), Mel-Frequency Cepstral Coefficients (MFCC), spectral stationarity, and correlation map sum to build a Gaussian Mixture Model (GMM) modeling speech, music, and noise probabilities of the frame. The first stage decision is based on voice activity detection flag and a smoothed GMM score. The second stage speech/music classifier refines the decision by analyzing the signal for stability, calculating the variance of correlation, analyzing attacks on a high resolution of 32 subframes, detecting tonal signals and calculating the spectral peak to average ratio.

Certain adaptations can be made for a FD encoding scheme to handle the encoding of transient signals. For example, as done in the ITU-T G.719 codec (ITU-T, “G.719: Low-complexity, full-band audio coding for high-quality, conversational applications”, 2008 Jun. 13), the time resolution of the transform blocks may be increased based on a transient detector, but there are other methods as well, as described herein.

There currently exist certain challenge(s).

In cases of signals with strong transients, existing classification schemes selecting the coding scheme may make a codec switch from TD (ACELP) to FD (TCX) encoding or if already operating in FD encoding mode, stay in the FD coding mode. This has been found to introduce audible and annoying time domain (TD) smearing in the FD compression scheme decoded signal, especially when there are strong transients in certain time positions of the Frequency Domain analysis frame.

The TD smearing results in an increased noise level prior to the transient in time or an increased noise level after the transient. The human ear is much more sensitive to the smearing prior to the transient as this is often perceived as an annoying pre-echo artifact. When the smearing occurs after the transient (a.k.a. post-echo artifact) the smearing is better perceptually masked by the encoded transient signal, but may still be perceived as annoying, e.g., depending on the amount of smearing.

If FD encoding is used while there are strong transients in the current frame or parts of the preceding frame, for the case the transform window covers samples both in current and part of the preceding frame (see FIG. 1), there can be annoying pre- and post-echo artifacts in the decoded signals. Especially when a low energy dynamics period is followed by a transient or a transient is followed by a low energy dynamics period in the same coding block, a wider transform block will increase the amount of audible quantization noise, causing a time domain smearing effect.

The time domain smearing inside a FD transform coding scheme is typically handled by four FD methods, see references: 3GPP TS 26.445 V16.1.1 (2020 December), “Codec for Enhanced Voice Services (EVS); Detailed Algorithmic Description”, section: “5.3.2.3 Transient location dependent overlap and transform length”; and Fuchs et al, “LOW DELAY LPC AND MDCT-BASED AUDIO CODING IN THE EVS CODEC”, 2015 IEEE International Conference on Acoustics, Speech and Signal Processing (ICASSP), 2015.

The four FD methods are:
a. Using a technique switching to shorter FD-transform blocks (at the cost of reduced frequency resolution).
b. Applying temporal noise shaping (TNS), e.g., by linear prediction in FD domain, to reduce the smearing in the time domain.
c. Using a technique of adjusting the window shape while maintaining the transform block length and the frequency resolution. The front-end of the MDCT analysis window may be adapted on-the-fly without incurring additional delay. Sharper front-end analysis MDCT windows however imply a reduced energy separation capability of the transform, so the default is typically to use a smooth window with longer overlap to get better energy separation. See section 5.3.2.3 of 3GPP TS 26.445 V16.1.1 (2020 December) for further details.
d. Applying a decoder side postfilter attenuating areas before and/or after the transient in time.

Method a) and method b) will increase the bit rate, so for low bit rate encoding an alternative method is desirable. However, method d) only helps as a band-aid, typically not providing a very high fidelity for smeared sections and may introduce distortion even at high bit rates. Finally, method c), can only handle a few possible transient locations, that is when the transient is located in a certain part of a lookahead section of the MDCT analysis window. Thus, method c) would typically have to be combined with one of {a), b), d)} to better handle all locations of a strong transient. On top of only handling front-end transients there is a bit rate cost for method c) due to the required signaling of the front-end transform window shape(s).

### SUMMARY

Instead of mitigating the impact of strong transients in the FD, a TD coding approach may be utilized to get better control of the temporal shape of encoded transient signals. Typically, a multi-mode codec utilizing both TD and FD encoding techniques, would select TD coding when speech is detected and switch to FD coding when music or non-speech signals are detected. However, as both speech signals and music signals may contain transients (and attacks), the speech/non-speech or speech/music distinction does not always end up in the subjectively best quality.

Certain aspects of the disclosure and their embodiments may provide solutions to these or other challenges. According to some embodiments, multi-mode codec adaptively forces a selection of a TD coding scheme (e.g., ACELP) for encoding of transients, even though the signal may have been initially classified to be encoded using a FD coding scheme (e.g., TCX MDCT mode in the EVS codec) by a speech/music classification stage. Moreover, the solution is not closed loop nor emulating a closed loop solution, where the decision on the encoding scheme would be based on selecting the best performing coding mode, e.g., by computing SNR (signal-to-noise ratio) values, based on synthesizing outputs (or approximated outputs) of the encoding and decoding of both FD and TD schemes.

According to a first aspect there is presented a method in an encoder to adjust a coding scheme selection when detecting a transient in an input sound signal. The encoder encodes the input signal in frames using a frequency-domain, FD, coding scheme or time-domain, TD, coding scheme. The method comprises detecting one or more of a transient attack and a transient release in the input signal and a location of the one or more of the transient attack and the transient release in at least one of a current frame and a previous frame. Based on a plurality of conditions associated with the one or more of the transient attack and the transient release it is determined whether or not to force a TD coding scheme, and selecting the TD coding scheme responsive to determining that the TD coding scheme is forced to be used.

According to a second aspect there is presented an apparatus comprising means for performing the method according to the first aspect.

According to a third aspect there is presented an encoder comprising a processing circuitry and a memory coupled with the processing circuitry, wherein the memory includes instructions that when executed by the processing circuitry causes the encoder to perform operations comprising detecting one or more of a transient attack and a transient release in the input signal and a location of the one or more of the transient attack and the transient release in at least one of a current frame and a previous frame while encoding an input signal in frames using a frequency-domain, FD, coding scheme or time-domain, TD, coding scheme. The operations comprise determining whether or not to force a TD coding scheme to be used based on a plurality of conditions associated with the one or more of the transient attack and the transient release, and selecting the TD coding scheme responsive to determining that the TD coding scheme is forced to be used.

According to a fourth aspect there is presented an encoder adapted to perform operations comprising detecting one or more of a transient attack and a transient release in the input signal and a location of the one or more of the transient attack and the transient release in at least one of a current frame and a previous frame while encoding an input signal in frames using a frequency-domain, FD, coding scheme or time-domain, TD, coding scheme. The encoder is adapted to determine whether or not to force a TD coding scheme to be used based on a plurality of conditions associated with the one or more of the transient attack and the transient release, and to select the TD coding scheme responsive to determining that the TD coding scheme is forced to be used.

According to a fifth aspect there is presented a computer program comprising program code to be executed by processing circuitry of an encoder, whereby execution of the program code causes the encoder to perform operations comprising detecting one or more of a transient attack and a transient release in the input signal and a location of the one or more of the transient attack and the transient release in at least one of a current frame and a previous frame while encoding an input signal in frames using a frequency-domain, FD, coding scheme or time-domain, TD, coding scheme; determining whether or not to force a TD coding scheme to be used based on a plurality of conditions associated with the one or more of the transient attack and the transient release; and responsive to determining that the TD coding scheme is forced to be used, selecting the TD coding scheme.

According to a sixth aspect there is presented a computer program product comprising a non-transitory storage medium including program code to be executed by processing circuitry of an encoder, whereby execution of the program code causes the encoder to perform operations comprising detecting one or more of a transient attack and a transient release in the input signal and a location of the one or more of the transient attack and the transient release in at least one of a current frame and a previous frame while encoding an input signal in frames using a frequency-domain, FD, coding scheme or time-domain, TD, coding scheme. The operations comprise determining whether or not to force a TD coding scheme to be used based on a plurality of conditions associated with the one or more of the transient attack and the transient release, and selecting the TD coding scheme responsive to determining that the TD coding scheme is forced to be used.

Certain embodiments may provide one or more of the following technical advantage(s). An advantage that may be achieved is an improved encoding and synthesis quality for signals with strong transients such as percussive single instruments (e.g., castanets) compared to a compression scheme not using the described embodiments. Another advantage that may be achieved is that embodiments may be adapted so that no harm is done to the resulting quality when the input signal contains a harmonic background.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration showing how the transient analysis subframe slots align with the various TCX transform windows and the past and current ACELP frames according to some embodiments;

FIG. 2 is a block diagram of an example of an operating environment in which an encoder and a decoder in which an adaptive mode selection can be implemented according to some embodiments;

FIGS. 3A-3C are graphs illustrating how an input signal showing pre-echo is decoded with a prior solution and decoded according to some embodiments of the present disclosure;

FIGS. 4A-4C is a graph illustrating how an input signal showing post-echo is decoded with a prior solution and decoded according to some embodiments of the present disclosure;

FIG. 5 is an illustration showing how the transient analysis subframe slots align with the various TCX transform window(s), the ACELP end of past synthesis line and the subframes to analyze according to some embodiments;

FIGS. 6 and 7 are flow charts illustrating operations of an encoder according to some embodiments;

FIG. 8 is a graph illustrating a strong transient that falls between transient analysis subframes −5 and −4 where a regular transient detector (not operating in the reversed time direction) will detect a transient only at subframe −5 even though part of the energy from the transient also falls into subframe −4;

FIGS. 9-12 are flow charts illustrating operations of an encoder according to some embodiments;

FIG. 13 is a block diagram of an encoder and a decoder illustrating where an adaptive mode selection can be implemented in a stereo codec according to some embodiments;

FIG. 14 is a block diagram of an encoder and a decoder illustrating where an adaptive mode selection can be implemented in an audio codec such as a multichannel or mono codec according to some embodiments;

FIG. 15 is a block diagram of an encoder in accordance with some embodiments;

FIG. 16 is a block diagram of a decoder in accordance with some embodiments;

FIG. 17 is a block diagram of a host computer in accordance with some embodiments; and

FIG. 18 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

In the present disclosure:
the term “attack” refers to a low-to-high energy change of an audio signal, for example voiced onsets (including transitions from an unvoiced speech segment to a voiced speech segment), and other speech sound onsets, transitions, plosives, etc., generally characterized by an abrupt energy increase within a speech signal segment.
the term “release” refers to energy decay towards a low energy preceded by a low-to-high energy change.
the term “transient” refers to a low-to-high energy change of any audio signal followed by a relatively fast decay towards low energy again, i.e., an attack may become a transient if followed by a release (energy drops off).

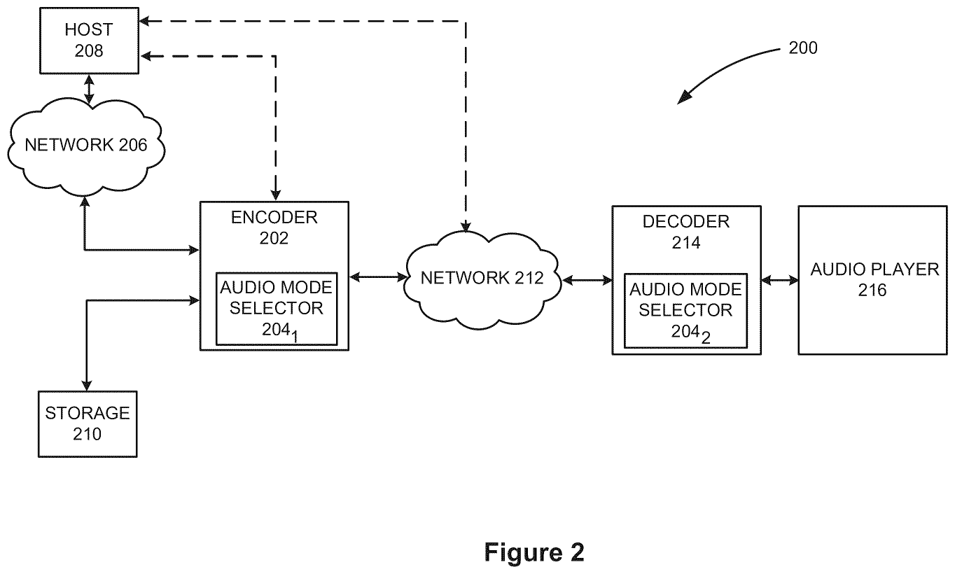

Prior to discussing the various embodiments of adjusting a compression scheme selection, an example of an operating environment shall be described. FIG. 2 illustrates an example of an operating environment in which the various embodiments of the present disclosure may be implemented. Turning to FIG. 2, in the example operating environment 200, the encoder 202 having an audio mode selector 2041 as described herein receives data, such as an audio file, to be encoded from an entity through network 206, such as a host 208, and/or from storage 210. In some embodiments, the host 208 may communicate directly to the encoder 202. The encoder 202 encodes the audio file as described herein and either stores the encoded audio file in storage 210 or transmits the encoded audio file to a decoder 214 having an audio mode selector 2042 via network 212. The decoder 214 uses the audio mode selector 2042 within the decoder 214 to decode the audio file and transmit the decoded audio file to an audio player 216 for playback. For example, the audio player 216 may play the decoded audio file for a spatial audio representation such as a Virtual Reality conference or computer game. The audio player 216 may be or be comprised in a user equipment, a terminal, a mobile phone, and the like. In other embodiments, the host 208 may transmit encoded audio files to the decoder 214 via network 212.

As previously indicated, the present disclosure enables adaptively forcing a selection of a TD coding scheme (e.g., ACELP) for encoding of transients, even though the signal may have been initially classified to be encoded using a FD coding scheme (e.g., TCX MDCT mode in the EVS codec) by a speech/music classification stage. Moreover, the solution is not closed loop nor emulating a closed loop solution, where the decision on the encoding scheme would be based on selecting the best performing coding mode, e.g., by computing SNR values, based on synthesizing outputs (or approximated outputs) of the encoding and decoding of both FD and TD schemes.

The present disclosure describes adjusting a compression scheme selection when detecting a transient or attack in a sound signal to be coded, for example music or speech or in any audio signal.

In one embodiment the various embodiments operate on a stereo encoder and decoder. The stereo encoder processes the input signals of the left and right channel in frames of ms. A transient detector is run on the signals of each of the channels and captures the location of transients in each channel. For a stereo encoder, the left and right channels may be 20 downmixed to a mid-channel accompanied by side information containing additional side signals and/or parameters describing the stereo image. The mid channel, which is referred to as the downmix channel, has typically larger energy than the side channel and consumes typically more of the bits for the encoding than what is spent on the side information.

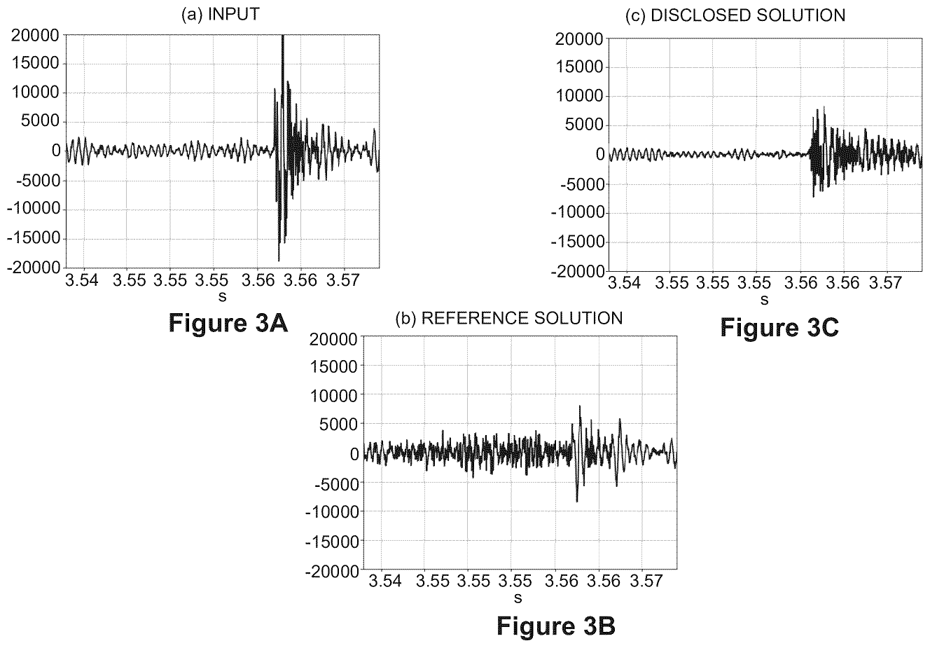

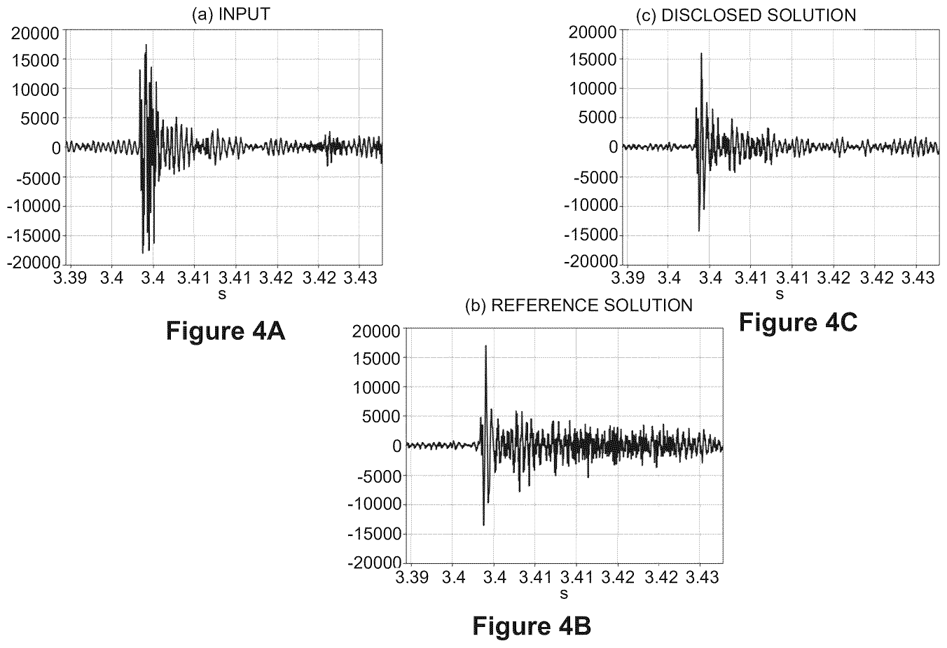

In some embodiments, a determination is made to identify if the input signal contains a problematic transient (attack or release) based on forward and reverse time direction signal analysis. The adaptive selection of a TD coding scheme avoids the smearing distortion otherwise caused by the FD block transform, as seen in FIG. 3C and FIG. 4C while maintaining quality benefits of FD coding. In FIG. 3C, the signal energy prior to the transient attack is being significantly lower compared to for the reference solution in FIG. 3B, which better matches the input signal in FIG. 3A. In FIG. 4C, the signal energy following the transient release is being significantly lower compared to the reference solution in FIG. 4B, which better matches the input signal in FIG. 4A. Although the TD coding scheme handles transients better, it may be at the cost of somewhat worse compression performance, especially within higher frequency regions. This is because most TD compression schemes focus their error minimization on the low frequency region and cannot efficiently compress all types of signals. Therefore, it is not desirable to always utilize a TD coding scheme, but an adaptive selection of the coding mode is desirable for certain signals containing strong transients.

The adaptive selection of the coding mode is based on detecting transients and their locations in a current and past frame, and analysis of the harmonicity of the input signal. The transient detection thresholds are based on the harmonicity of the signal. Two primary (i.e., high-level) conditions are required to force a selection of a TD coding scheme. These two primary conditions are that 1) the transform block of a FD coding scheme contains a transient (transient attack and/or transient release) and 2) the signal is not considered to be harmonic.

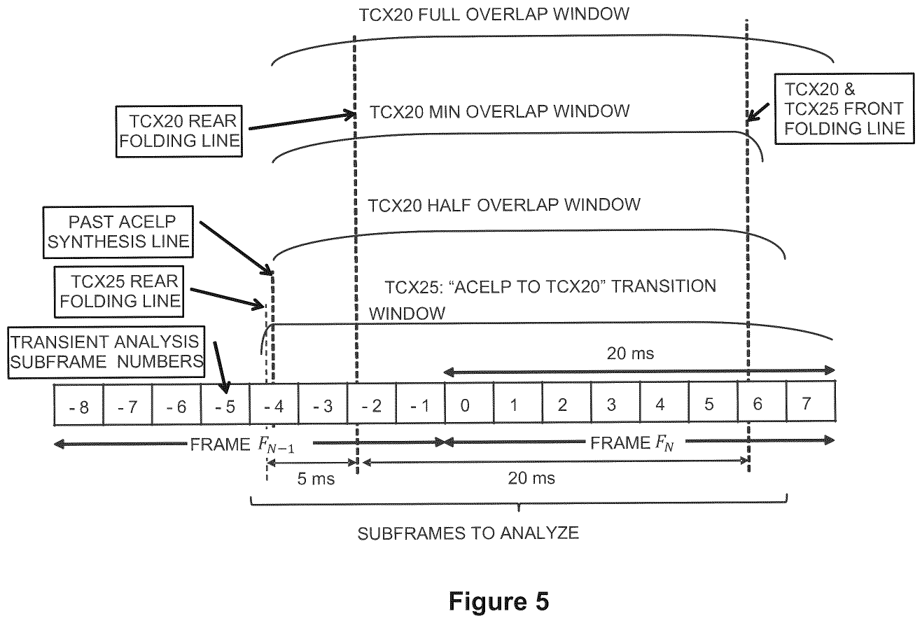

In one embodiment the two primary conditions are evaluated using three conditions. The three conditions, (c₁, c₂, c₃), are evaluated to get a decision on whether to force a selection of a TD coding scheme or not. The first condition, c₁, is whether a transient is detected in the current frame, F_{N}, excluding the last subframe as shown in FIG. 5. The second condition, c₂, to be checked especially when the previous frame was a TD frame, is whether a transient was detected in the last half of the previous frame, F_{N-1}. The third condition, c₃, is whether the signal is harmonic. The decision to force a TD coding scheme is given by forceTD=(c₁|c₂) & ! c₃. The third condition c₃ being fulfilled (true) indicates the signal is harmonic while ! c₃, i.e., c₃ not being fulfilled (false), indicates the signal is not harmonic. In other words, the TD coding scheme is forced when the conditions c₁ or c₂ are fulfilled and the condition c₃ is not fulfilled (i.e., c₃ indicates that the signal is not harmonic). The decision on the encoding scheme is set to TD encoding if forceTD is set otherwise the encoding scheme is determined by the speech/music classifier.

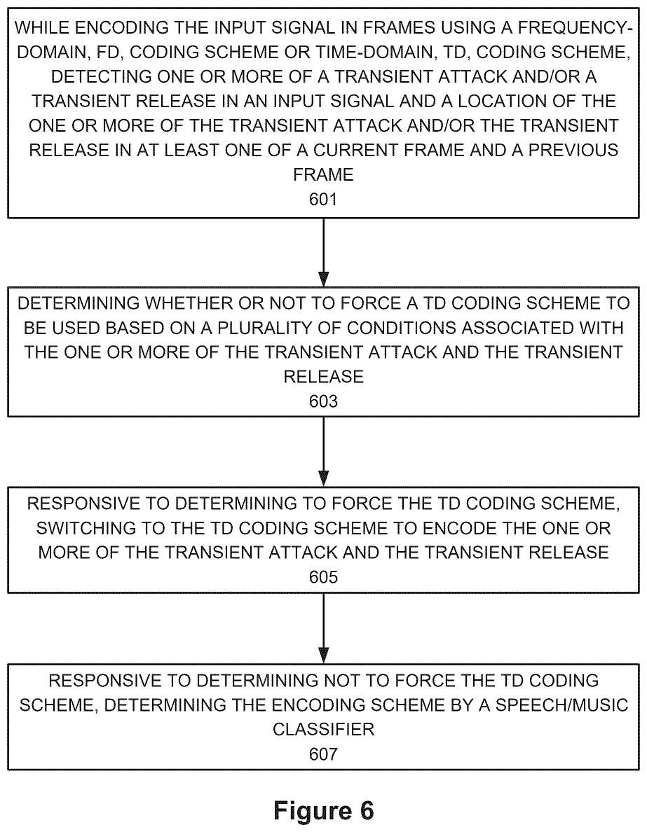

This is illustrated in FIG. 6 where in block 601, the encoder 202, while encoding the input signal using a frequency-domain, FD, coding scheme or time-domain, TD, coding scheme, detects one or more of a transient attack and a transient release in an input signal and a location of the one or more of the transient attack and the transient release in at least one of a current frame and a previous frame. In other words, the encoder 202 detects a transient attack or a transient release or a transient attack and a transient release.

In block 603, the encoder 202 determines whether or not to force a TD coding scheme to be used based on a plurality of conditions associated with the transient or attack. In block 605, responsive to determining to force the TD coding scheme, the encoder 202 switches to the TD coding scheme. If the current coding scheme is the TD coding scheme, the switching to the TD coding scheme is to keep using the TD coding scheme. Additional conditions may be used.

The first condition, c₁, addresses both forward and backward spreading (and smearing) caused by the scarcity of bits in the low-rate FD TCX20 compression scheme, where TCX20 is a regular MDCT frame type producing 20 ms of synthesized output signal. The reason to not include the last subframe, of index 7 in FIG. 5, is that the front-end of the window function is assumed to be shortened in case there would be a transient in this subframe. If this is not the case, this subframe should also be part of the analysis for the first condition, c₁.

The second condition, c₂, addresses smearing caused by the suboptimal transition window (TCX25) used when switching from TD(ACELP) to FD(TCX) coding. TCX25 is an MDCT frame type that may produce 25 ms of synthesized output signal. The additional 5 ms of synthesis compared to TCX20 are required to fill up the MDCT overlap-add (OLA) buffer used by the TCX operation in transitions from ACELP from to TCX coding. If there is a strong transient in the end of the TD coded frame, part of its energy might be included in the beginning of the FD coded frame, which then causes smearing.

The third condition, c₃, is restricting the switch to TD for signals with high harmonicity when the low-rate TD coding mode is likely not performing as well as the FD coding, e.g., due to the limited high-frequency encoding quality, and/or the switch to TD coding mode causing switching artifacts that are perceptually harmful.

A speech/music classifier is used to get an initial decision of the encoding scheme to use for the channel, either a TD scheme or a FD scheme. A harmonicity flag is computed to indicate if the signal is harmonic. Long-term harmonicity may be indicated by analyzing the spectral peak-to-average (P2A) or spectral peak-to-noise (P2N) long-term correlation between frames. Short-term harmonicity maybe indicated by analyzing the P2A or the P2N for a set of spectral peaks within the current frame and establish if they are harmonically related.

A preferred variation of peak-to-noise analysis is a method of determining a harmonicity flag by analyzing the long-term evolution of energy spectral peaks across frames as follows, similar in scope to the harmonic detection method as used in the EVS codec and illustrated in the flowchart of FIG. 7:
1. Compute log bin energy spectra of both the current frame's and previous frame's channel (e.g., a downmix channel). This is illustrated in block 701 of FIG. 7 where the encoder 202 computes log bin energy spectra for a signal (e.g., of a downmix channel) of the current frame and a signal (e.g., of a downmix channel) of the previous frame.
2. From the bin energies, subtract an estimated noise floor, and compute the correlation between the current and previous frame in a band centered around each peak to get a correlation map. This is illustrated in block 703 of FIG. 7 where the encoder 202 subtracts, from the log bin energy spectra, an estimated noise floor and computes a correlation between the current frame and the previous frame in a band centered around each peak to obtain a correlation map.
3. Sum the correlation map values and lowpass filter the correlation map sum over frames. This is illustrated in block 705 of FIG. 7 where the encoder 202 sums correlation map values and lowpass filters the correlation map values sum over frames.
4. If the long-term correlation map sum, CMS_{LT}, is above a certain threshold, θₕₐᵣₘ, classify the signal as harmonic and set the harmonicity flag. This is illustrated in block 707 of FIG. 7 where the encoder 202, if a long-term correlation map sum, CMS_{LT}, is above a predetermined threshold, θₕₐᵣₘ, classifies the signal as harmonic and sets a harmonicity flag indicating the signal is harmonic. The predetermined threshold θₕₐᵣₘ may be set based on another predetermined threshold, θₕₐᵣₘ, to θₕₐᵣₘ=βθₕₐᵣₘ where β may be set to 1 or 0.9<β<1.4.
5. Update θₕₐᵣₘ. This is illustrated in block 709 of FIG. 7 where the encoder 202 updates θₕₐᵣₘ. For example, when θₕₐᵣₘ=βθₕₐᵣₘ, it can be updated by updating θₕₐᵣₘ and then determining θₕₐᵣₘ using θₕₐᵣₘ=βθₕₐᵣₘ. θₕₐᵣₘ can be updated by: If θₕₐᵣₘ is below a hard threshold, θ_{hard}, increment θₕₐᵣₘ otherwise decrement θₕₐᵣₘ by a step δ with the constraint that the updated value of θₕₐᵣₘ remains within the limits harm_{high} and harm_{low}. θ_{hard}, δ, harm_{high}, harm_{low} may for example be set to 56, 0.2, 60, and 49 respectively. Initial value of θₕₐᵣₘ may be set to 56.

FIG. 5 shows the alignment of FD analysis windows with respect to the subframes in the current and preceding frame. A transient location in the preceding frame, for example at subframe {−3} will lead to annoying post-echo artifacts, and it is typically preferable to select TD encoding mode instead. The main reason of the post-echo smearing-like artifacts in the ACELP-to-TCX frame (TCX25) with high energy in positions −3 (and −4) is due to an abrupt transition from the preceding rectangular ACELP last 2-3 ms synthesis to the initial few (4-5) ms synthesis of the TCX25 FD domain frame; a transition which is in the vicinity of the TCX25 MDCT rear folding line.

However, for signals with a high degree of harmonicity, the switching to another coding mode may cause annoying distortions which makes it better not to always switch encoding mode. Various embodiments therefore take the harmonicity of the signals into consideration in selecting the encoding mode for transient signals.

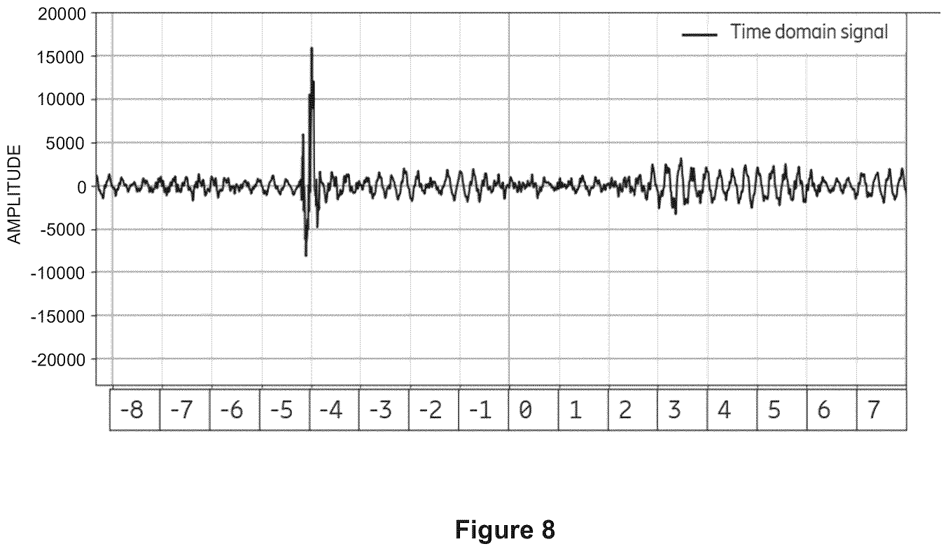

FIG. 9 illustrates operations the encoder 202 performs based on the harmonicity flag in some embodiments. If the harmonicity flag is set, meaning there is a high degree of harmonicity in the signal, the encoding mode is not changed with respect to potential transients. Thus, as illustrated in block 901 of FIG. 9, the encoder 202, responsive to the harmonicity flag being set, does not change the encoding scheme. However, if the harmonicity flag is not set, transient analysis is done to determine whether to force the selection of a TD encoding scheme, taking into consideration the location and strength of the one or more of the transient attack and the transient release. This is illustrated in block 903 of FIG. 9 where the encoder 202, responsive to the harmonicity flag not being set, performs transient analysis to determine whether to force the selection of a TD encoding scheme, taking into consideration the location and strength of the one or more of the transient attack and the transient release. The subframes analyzed on each audio channel for transients are the ones that fall within the transform window that would be encoded if an FD encoding scheme would be used.

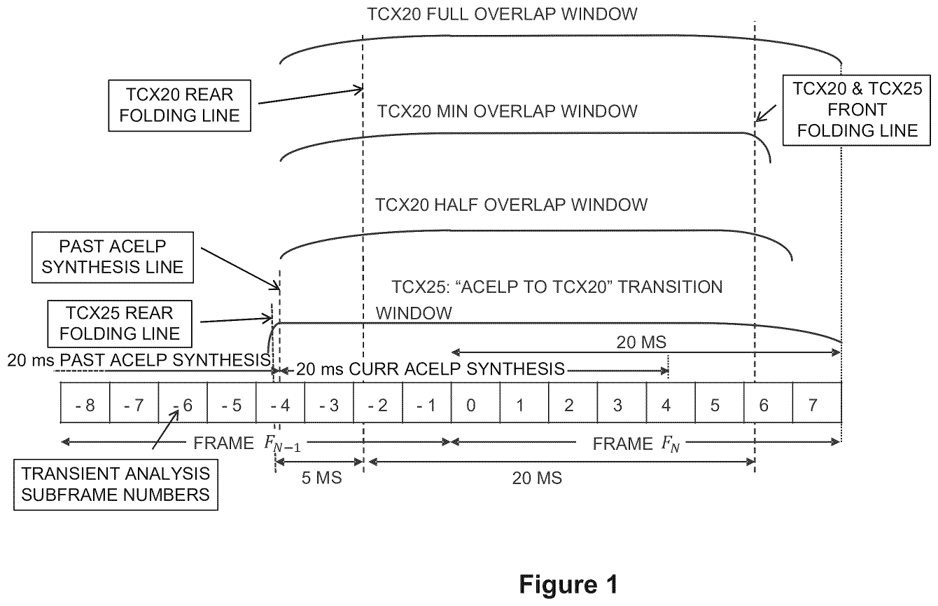

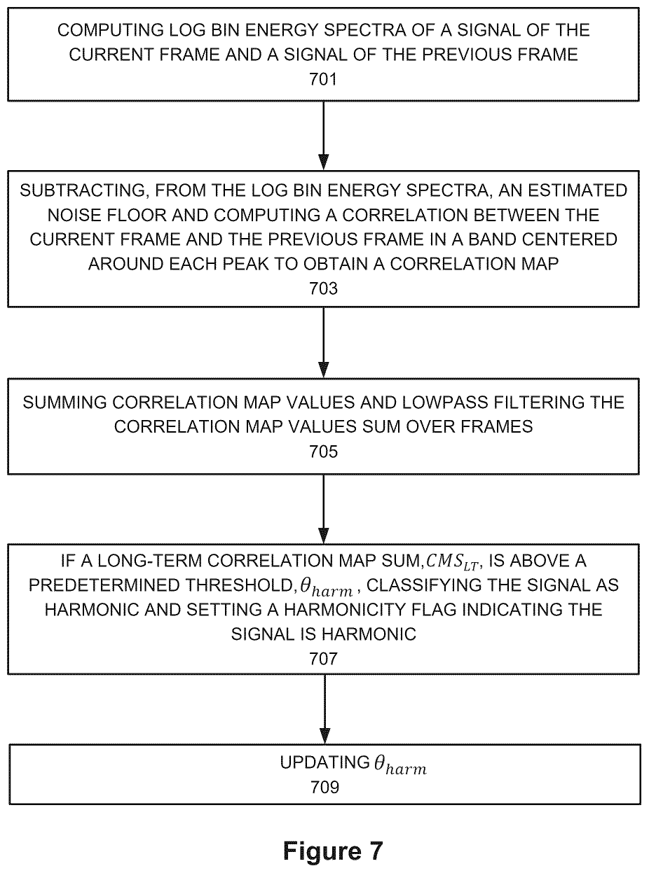

For the example of FIG. 1 this corresponds to subframes {−4, 6} as illustrated in FIG. 8. For a transient in subframe 7, the handling of the front-end transient energy is deferred to the next frame, by using the existing min, half and full frame window adaptation as in EVS. For subframes {−2, 6} a transient detector similar to that described above, with a threshold, θ_{fwd}, dependent on the harmonicity of the signal is used. θ_{fwd} is set to θ_{fwd1} if the long-term correlation map sum, CMS_{LT}, is almost reaching the harmonic threshold, otherwise it is set to θ_{fwd2}. That is, if CMS_{LT} e.g. is above 80% of θₕₐᵣₘ set θ_{fwd} to θ_{fwd1} otherwise set it to θ_{fwd2}. If a transient is detected, the preliminary flag to force a selection of TD encoding, forceTDₚᵣₑₗ is set.

For subframes {−3} and {−4} an additional analysis is done to detect a potentially harmful transient release whose energy might spread too much into the current frame to be encoded even though the transient (attack) was actually detected in the previous frame. FIG. 8 shows an example where a transient is detected at subframe {−5} belonging to the previous frame but part of the energy spreads to subframe {−4}. It should be noted that even a strong transient starting as early as in subframe {−6} and detected by a forward transient detector to be located in subframe {−6}, may result in a significant amount of energy falling in subsequent subframes {−4} and {−3}.

For this, an improved transient detector scheme is used to detect the transient release, for example using the transient detector described above, however operated in the reversed time direction and using thresholds, θ_{rev_high}, θ_{rev_low}, which are preferably lower than the thresholds, θ_{fwd1}, θ_{fwd2}, used for the transient attack detection. θ_{rev_high} and θ_{rev_low} are determined based on the harmonicity of the signal, that is, if the long-term correlation sum, CMS_{LT}, is above 60% of the harmonic threshold, θₕₐᵣₘ, set θ_{rev_high} and θ_{rev_low} to θ_{rev1_high} and θ_{rev1_low} respectively, otherwise set θ_{rev_high} and θ_{rev_low} to θ_{rev2_high} and θ_{rev2_low} respectively.

FIG. 10 illustrates operations the encoder 202 performs in some embodiments in detecting the one or more of the transient attack and the transient release in the input signal in at least one of the current frame and the previous frame using an improved transient detector. Turning to FIG. 10, in block 1001, the encoder 202 divides the at least one of the current frame and the previous frame into a plurality of subframes denoted as Sᵢ[j], where j is a j^{th} sample in an i^{th} subframe. In block 1003, the encoder 202, for each subframe, computes an energy of the subframe,

$${E}_{i} = {\sum }_{j = 0}^{k - 1} {{S}_{i} [ j ]}^{2} ,$$

where k is a number of samples in the subframe.

In block 1005, the encoder 202 computes a lowpass filtered max energy envelope for each subframe, accEᵢ. In block 1007, the encoder 202 detects if there is one or more of the transient attack and the transient release in a main part of a windowed signal by checking if the subframe energy is substantially above accE by a threshold θ_{fwd}, dependent on the harmonicity of the signal where θ_{fwd} is set to θ_{fwd1} if the long-term correlation map sum, CMS_{LT}, is above or equal to a predetermined setpoint of the harmonic threshold θₕₐᵣₘ, otherwise θ_{fwd} is set to θ_{fwd2}. In some embodiments the predetermined setpoint is 80%.

FIG. 11 illustrates detecting a transient release according to some embodiments. Turning to FIG. 11, in block 1101, the encoder 202 detects a transient release by using the transient detector in a reversed time direction using thresholds θ_{rev_high}, θ_{rev_low}, where θ_{rev_high} and θ_{rev_low} are determined based on the harmonicity of the signal.

FIG. 12 illustrates an embodiment of how θ_{rev_high} and θ_{rev_low} are determined. Turning to FIG. 12, in block 1201, the encoder 202 responsive to a long-term correlation sum, CMS_{LT}, being above or equal to a second predetermined threshold of the harmonic threshold, θₕₐᵣₘ, sets θ_{rev_high} to θ_{rev1_high} and θ_{rev_low} to θ_{rev1_low}. In block 1202, the encoder 202, responsive to a long-term correlation sum, CMS_{LT}, being below the second predetermined threshold, sets θ_{rev_high} to θ_{rev2_high} and θ_{rev_low} to θ_{rev2_low}.

For the reverse analysis of subframe {−3} it is checked whether the transient release energy is above Prev low, and if that is the case, forceTDₚᵣₑₗ is set, forcing the coding scheme to be TD (ACELP) as using an FD encoding scheme might lead to smearing.

For the reverse analysis of subframe {−4} it is checked whether a transient release is detected with both thresholds θ_{rev_low} and θ_{rev_high}, where θ_{rev_high} is preferably higher than θ_{rev_low}. If a transient release is detected with threshold θ_{rev_high}, the forceTDₚᵣₑₗ flag is set. If the transient release is detected with only threshold θ_{rev_low}, it is additionally checked whether the energy of the second half is greater than the first half of subframe {−4}, and if that is the case, the forceTDₚᵣₑₗ flag is set. The reason for the additional high resolution time domain analysis within subframe {−4} is that: only a part of the 1^{st} half of the subframe actually falls within the TCX25 transform window and that the signal is weighted by the TCX25 window, so if most energy is located in the 2^{nd} part of subframe {−4} then there might be smearing even though the energy is lower than limit θ_{rev_high}.

In all other cases forceTDₚᵣₑₗ is not set. The final decision, forceTD, on whether to force a TD encoding scheme may be taken if either of the preliminary flags, forceTDₚᵣₑₗ, from each channel is set. That is, forceTD=(forceTD_{L}|forceTD_{R}), where forceTD_{L} and forceTD_{R} are the preliminary flags, forceTDₚᵣₑₗ, for the left and right channel respectively. The computation of forceTD is summarized in the pseudo code below:

$$forceTD = f ( {ch}_{left} ) \vert f ( {ch}_{right} )$$

where | corresponds to a logical OR operation and ƒ(chₙ) is the transient analysis block for the n^{th} channel where n is either left or right. Alternatively, the final decision forceTD may be based on logic combinations and between preliminary flags determined for each audio channel. For example, for multi-channel scenarios, the logical combination could be a weighted sum based on the energy of each channel. In another embodiment, the analysis may be performed on a downmix channel where the final decision is based on this analysis. chₙ is the subframe vector {Sᵢ[j],CMS_{LT},θₕₐᵣₘ} for each channel. The function ƒ is given by:

```
forceTD_{channel} = function f(chₙ )
  {
    forceTDₚᵣₑₗ = false
    if CMS_{LT} ≥ 0.8 * ϑₕₐᵣₘ
    {
      ϑ_{fwd} = θ_{fwd1}
    }
    else
    {
      ϑ_{fwd} = θ_{fwd2}
    }
    if CMS_{LT} ≥ 0.6 * ϑₕₐᵣₘ
    {
      ϑᵣₑᵥ_high = θᵣₑᵥ₁_high
      ϑᵣₑᵥ_low = θᵣₑᵥ₁_low
    }
    else
    {
      ϑᵣₑᵥ_high = θᵣₑᵥ₂_high
      ϑᵣₑᵥ_low = θᵣₑᵥ₂_low
    }
    for (i = − 2; i < 7; i = i + 1)
    {
      if Eᵢ > accEᵢ * ϑ_{fwd}:
      {
        forceTDₚᵣₑₗ = true
      }
    }
    if E₋₃ > accRevE₋₃ * ϑᵣₑᵥ_low
    {
      forceTDₚᵣₑₗ = true
    }
    else if E₋₄ > accRevE₋₄ * ϑᵣₑᵥ_high
    {
      forceTDₚᵣₑₗ = true
    }
    else if E₋₄ > accRevE₋₄ * ϑᵣₑᵥ_low
    {
      $e 0 = {\sum }_{j = 0}^{\frac{k}{2} - 1} {{S}_{- 4} [ j ]}^{2}$
      $e 1 = {\sum }_{j = \frac{k}{2}}^{k - 1} {{S}_{- 4} [ j ]}^{2}$
      if e1 > e0
      {
        forceTDₚᵣₑₗ = true
      }
    }
    return forceTDₚᵣₑₗ
  }
```

where:
chₙ is the subframe vector {Sᵢ[j],CMS_{LT},θₕₐᵣₘ} from the n^{th} channel, either left or right.
Eᵢ is the energy of subframe i.
accEᵢ is the lowpass filtered max energy envelope until subframe i as described in paragraph [0004].
accRevEᵢ is the lowpass filtered max energy envelope computed, similar to accEᵢ but in the reverse time direction using the buffer subframe energies Eᵢ until subframe i. That is:
   If i==mₛₜₐᵣₜ: initialize tmpE with Eₘ_{ₛₜₐᵣₜ}, where mₛₜₐᵣₜ is the subframe index the energy envelope filter state is initialized according to:

```
for (i = mₛₜₐᵣₜ; i > mₛₜₒₚ; i = i − 1)
{
  accRevEᵢ = tmpE
  tmpE = max(Eᵢ , α * tmpE)
},
```

where α is less than 1, e.g 0.8125. Here is mₛₜₒₚ the index to stop at just before the last subframe of interest, e.g. being {−4}. mₛₜₐᵣₜ and mₛₜₒₚ are 3 and −5 respectively. mₛₜₐᵣₜ can be varied but should not be too close to the region of major interest (which is {−4, −3}) since the energy envelope estimate around mₛₜₐᵣₜ will be inaccurate as fewer subframe are used, while on the other hand it cannot be chosen to be too distant as the envelope energy estimate will not be accurate for the region around mₛₜₒₚ.
k is the number of samples in each subframe.
Sᵢ[j] is the j^{th} sample in the i^{th} subframe.
θ_{fwd1}, θ_{fwd2}, θ_{rev1_high}, θ_{rev1_low}, θ_{rev2_high}, θ_{rev2_low} are threshold in the range between 4 and 9, which may e.g., be set to 8.5, 8.0, 5.5, 4.5, 5.25, and 4.25 respectively.

If the forceTD flag is set (to true), TD encoding scheme is selected irrespective of the preceding FD/TD (ACELP/TCX) classifier decision.

The encoded downmix channel and the encoded side information is put together into the bitstream and transmitted to the decoder. The decoder decodes the bitstream to retrieve the side information and the downmix signal. Stereo upmixing is done to get the left and right channel audio signals.

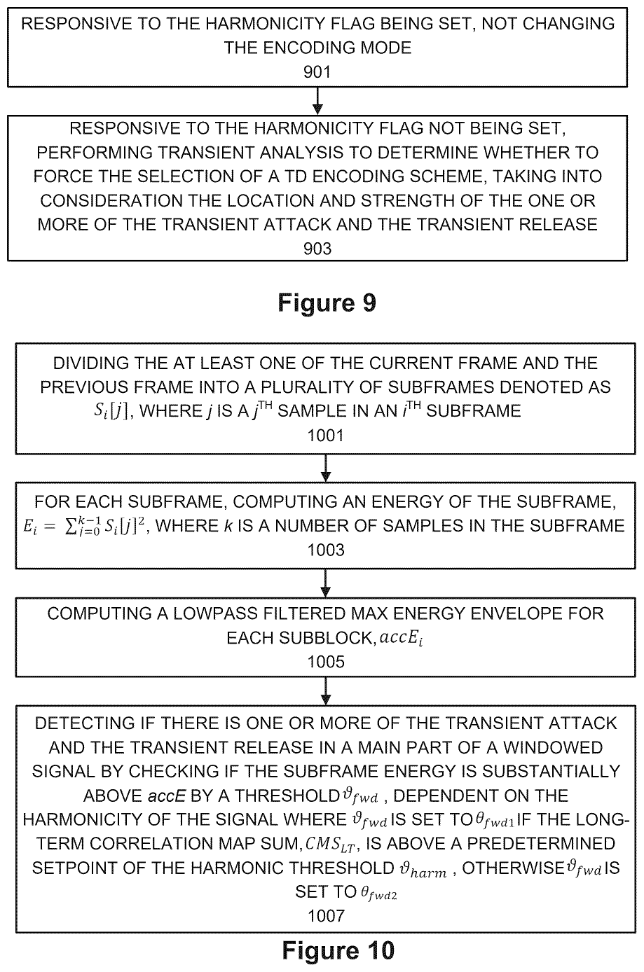

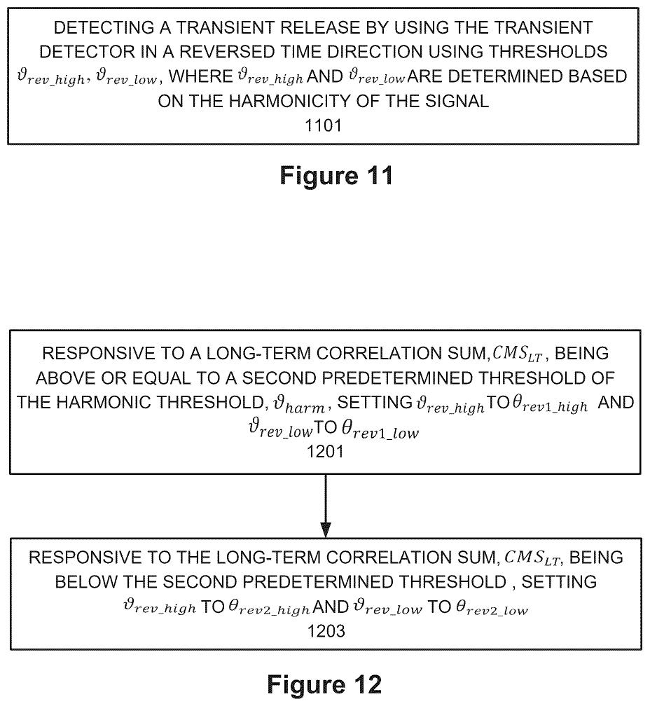

The proposed method can be realized in a stereo codec as shown in FIG. 13, or in either a multichannel or mono codec as shown FIG. 14, where the adaptive mode selector block in FIGS. 13 and 14 refers to the above described embodiments of the present disclosure.

In an embodiment the harmonicity flag is computed on the downmixed channel. Similarly, the computation of the forceTD flag may be based directly on the downmix channel rather than the left and right channel.

In another embodiment where the codec operates on a multi-channel signal, the speech/music classifier, harmonicity analysis and computation forceTD_prel is done per channel. The final forceTD is then set if either of the preliminary flags, forceTD_prel, from any of the channels is set or alternatively based on another combination of the preliminary flags of the channels.

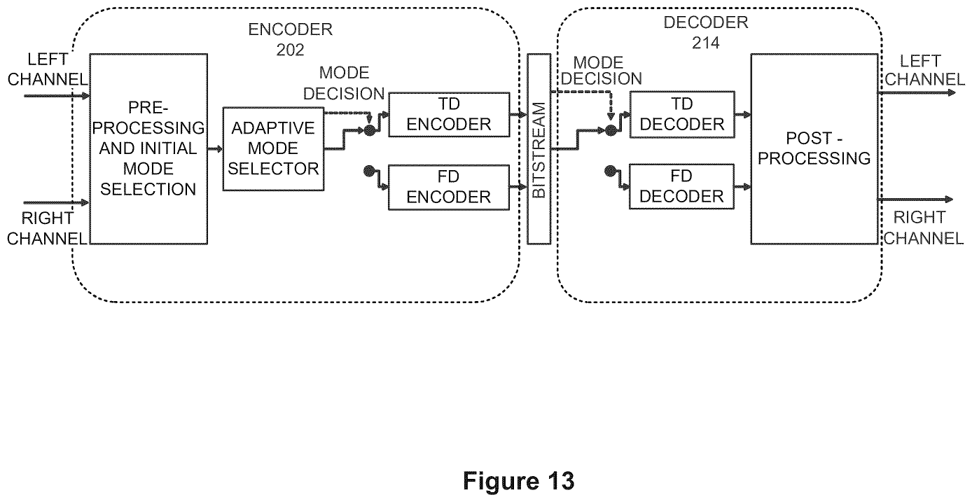

FIG. 15 shows an encoder 202 in accordance with some embodiments. As used herein, an encoder refers to a device capable, configured, arranged and/or operable to encode files and communicate wirelessly with network nodes, decoders, and/or other encoders. Examples of an encoder include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc.

An encoder may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, an encoder may not necessarily have a user in the sense of a human user who owns and/or operates the relevant device. Instead, an encoder may represent a device that is intended for sale to, or operation by, a human user but which may not, or which may not initially, be associated with a specific human user. Alternatively, an encoder may represent a device that is not intended for sale to, or operation by, an end user but which may be associated with or operated for the benefit of a user.

The encoder 202 includes processing circuitry 1502 that is operatively coupled via a bus 1504 to an input/output interface 1506, a power source 1508, a memory 1510, a communication interface 1512, and/or any other component, or any combination thereof. Certain encoders may utilize all or a subset of the components shown in FIG. 15. The level of integration between the components may vary from one encoder to another encoder. Further, certain encoders may contain multiple instances of a component, such as multiple processors, memories, transceivers, transmitters, receivers, etc. In its simplest form, an encoder 202 may have processing circuitry 1502, memory 1510, and communication interface 1512.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, an actuator, an emitter, a smartcard, another output device, or any combination thereof. An input device may allow a user to capture information into the encoder 202. Examples of an input device include a touch-sensitive or presence-sensitive display, a camera (e.g., a digital camera, a digital video camera, a web camera, etc.), a microphone, a sensor, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the encoder 202 via input circuitry or an interface such as an electrical power cable. Delivering power may be, for example, for charging of the power source 1508. Power circuitry may perform any formatting, converting, or other modification to the power from the power source 1508 to make the power suitable for the respective components of the encoder 202 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the encoder 202, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the encoder 202 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another encoder or decoder or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

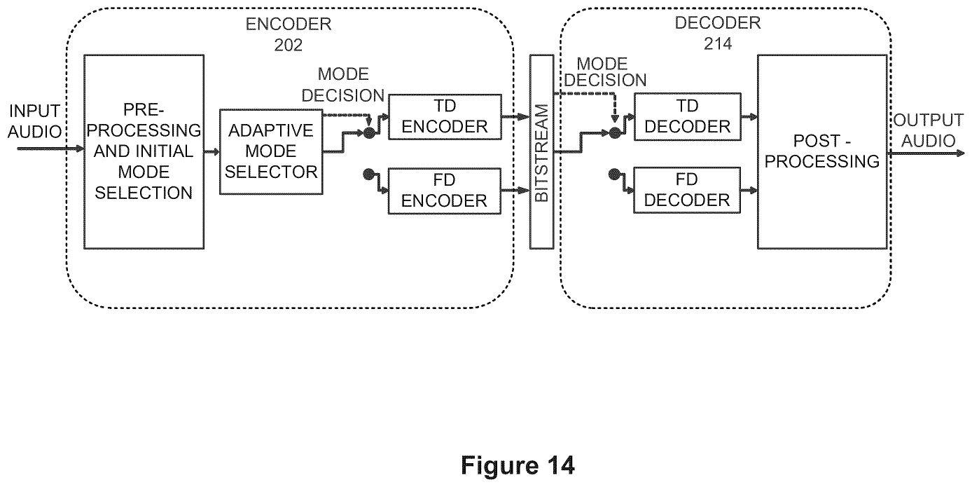

FIG. 16 shows a decoder 214 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The decoder 214 includes a processing circuitry 1602, a memory 1604, a communication interface 1606, and a power source 1608. The decoder 214 may be composed of multiple physically separate components (e.g., a NodeB component and a RNC component, or a BTS component and a BSC component, etc.), which may each have their own respective components. In certain scenarios in which the decoder 214 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the decoder 214 may be configured to support multiple radio access technologies (RATs). In such embodiments, some components may be duplicated (e.g., separate memory 1604 for different RATs) and some components may be reused (e.g., a same antenna 1610 may be shared by different RATs). The decoder 214 may also include multiple sets of the various illustrated components for different wireless technologies integrated into decoder 214, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within decoder 214.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other decoder 214 components, such as the memory 1604, to provide decoder 214 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the decoder 214. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between an encoder, a network node, access network, and/or decoder. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the decoder 214 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the decoder 214 and connectable to the decoder 214 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of decoder 214 in a form suitable for the respective components (e.g., at a voltage and current level needed for each respective component). The power source 1608 may further comprise, or be coupled to, power management circuitry to supply the components of the decoder 214 with power for performing the functionality described herein. For example, the decoder 214 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the decoder 214 may include additional components beyond those shown in FIG. 16 for providing certain aspects of the network node's functionality, including any of the functionality described herein and/or any functionality necessary to support the subject matter described herein. For example, the decoder 214 may include user interface equipment to allow input of information into the decoder 214 and to allow output of information from the decoder 214. This may allow a user to perform diagnostic, maintenance, repair, and other administrative functions for the decoder 214.

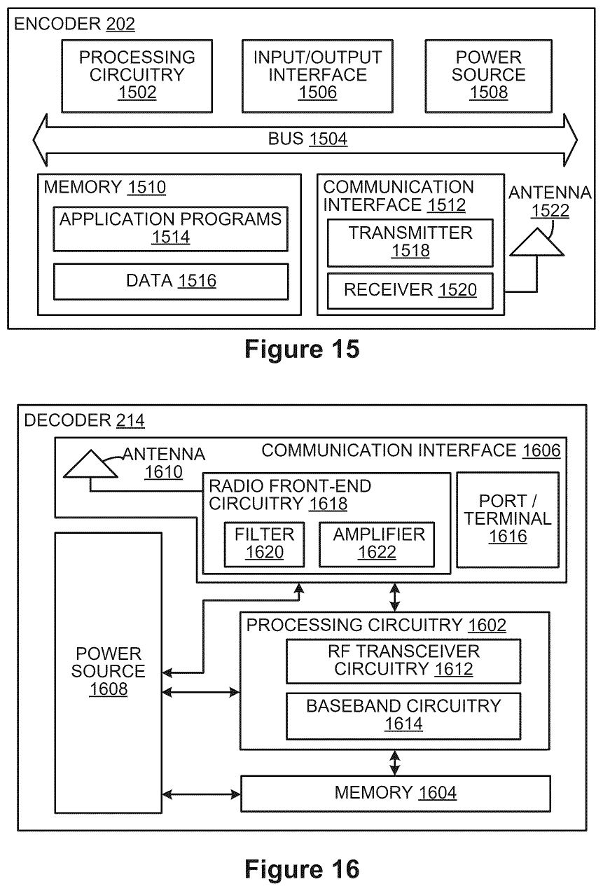

FIG. 17 is a block diagram of a host 208. As used herein, the host 208 may be or comprise various combinations hardware and/or software, including a standalone server, a blade server, a cloud-implemented server, a distributed server, a virtual machine, container, or processing resources in a server farm. The host 208 may provide one or more services to one or more encoders and decoders.

The host 208 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 208.

The memory 1712 may include one or more computer programs including one or more host application programs 1714 and data 1716, which may include user data, e.g., data generated by a UE for the host 208 or data generated by the host 208 for a UE. Embodiments of the host 208 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711, EVS), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 208 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

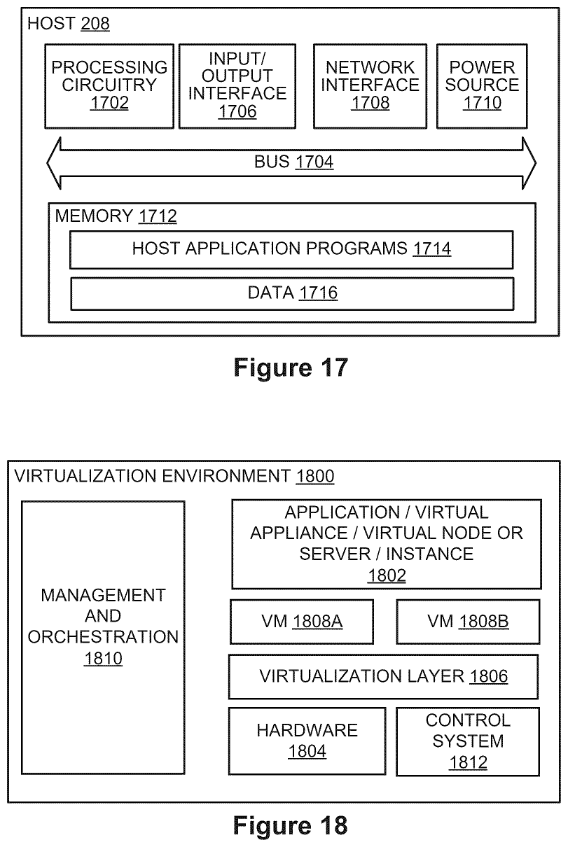

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808A and 1808B (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

Although the computing devices described herein (e.g., encoders, decoders, UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### EXAMPLE EMBODIMENTS

1. A method in an encoder (202, 1802) to adjust a compression scheme selection when detecting a transient or attack in a sound signal, the encoder encoding an input signal in frames, the method comprising:
while encoding the input signal in frames using a frequency-domain, FD, coding scheme or time-domain, TD, coding scheme, detecting (601) one or more of a transient attack and a transient release in an input signal and a location of the one or more of the transient attack and the transient release in at least one of a current frame and a previous frame;
determining (603) whether or not to force a TD coding scheme to be used based on a plurality of conditions associated with the one or more of the transient attack and the transient release; and
responsive to determining to force the TD coding scheme, switching (605) to the TD coding scheme to encode the one or more of the transient attack and the transient release.

2. The method of Embodiment 1, further comprising:
responsive to determining not to force the TD coding scheme, determining (607) the encoding scheme by a speech/music classifier.

3. The method of any of Embodiments 1-2, wherein the plurality of conditions comprises at least two primary conditions.

4. The method of Embodiment 3, wherein a first primary condition of the at least two primary conditions comprises determining whether the transform block of a FD coding scheme contains one or more of the transient attack and the transient release.

5. The method of Embodiment 4 wherein determining whether the transform block of a FD coding scheme contains one or more of the transient attack and the transient release comprises:
determining a first condition, c₁, comprising determining whether the transient or attack is detected in the current frame; and
determining a second condition, c₂, comprising determining whether the transient or attack was detected in a last half of the previous frame.

6. The method of Embodiment 5, wherein determining whether the transient or attack is detected in the current frame comprises determining whether the transient or attack is detected in the current frame excluding a last subframe.

7. The method of any of Embodiments 3-6, wherein a second condition of the at least two conditions comprises determining whether the signal is harmonic.

8. The method of Embodiment 7 wherein determining whether the signal is harmonic comprises determining whether a third condition, c₃, comprises determining whether the signal is harmonic.

9. The method of Embodiment 8, wherein determining whether or not to force the TD coding scheme to be used comprises determining to force the TD coding scheme responsive to c₁ or c₂ being fulfilled and c₃ indicating the signal is not harmonic.

10. The method of any of Embodiments 7-9, wherein determining whether the signal is harmonic comprises analyzing a long-term evolution of energy spectral peaks across frames by:
computing (701) log bin energy spectra of a signal of the current frame and a signal of the previous frame;
subtracting (703), from the log bin energy spectra, an estimated noise floor and computing a correlation between the current frame and the previous frame in a band centered around each peak to obtain a correlation map;
summing (705) correlation map values and lowpass filtering the correlation map values sum over frames;
if a long-term correlation map sum, CMS_{LT}, is above a predetermined threshold, θₕₐᵣₘ, classifying (707) the signal as harmonic and setting a harmonicity flag indicating the signal is harmonic; and
updating (709) θₕₐᵣₘ.

11. The method of Embodiment 10, further comprising:
responsive to the harmonicity flag being set, not changing (901) the encoding mode; and
responsive to the harmonicity flag not being set, performing (903) transient analysis to determine whether to force the selection of a TD encoding scheme, taking into consideration the location and strength of the one or more of the transient attack and the transient release.

12. The method of any of Embodiments 1-11, wherein detecting the one or more of the transient attack and the transient release in the input signal in at least one of the current frame and the previous frame using a transient detector that performs operations comprising:
dividing (1001) the at least one of the current frame and the previous frame into a plurality of subframes denoted as Sᵢ[j], where j is a j^{th} sample in an i^{th} subframe; for each subframe, computing (1003) an energy of the subframe,

$${E}_{i} = {\sum }_{j = 0}^{k - 1} {{S}_{i} [ j ]}^{2} ,$$

where k is a number of samples in the subframe;
computing (1005) a lowpass filtered max energy envelope for each subframe, accEᵢ;
detecting (1007) if there is one or more of the transient attack and the transient release in a main part of a windowed signal by checking if the subframe energy is substantially above accE by a threshold θ_{fwd}, dependent on the harmonicity of the signal where θ_{fwd} is set to θ_{fwd1} if the long-term correlation map sum, CMS_{LT}, is above or equal to a predetermined setpoint of the harmonic threshold θₕₐᵣₘ, otherwise θ_{fwd} is set to θ_{fwd2}.

13. The method of Embodiment 12 wherein the predetermined setpoint comprises 80%.

14. The method of any of Embodiments 12-13, wherein detecting the one or more of the transient attack and the transient release in the input signal further comprises detecting (1101) a transient release by using the transient detector in a reversed time direction using thresholds θ_{rev_high}, θ_{rev_low}, where θ_{rev_high} and θ_{rev_low} are determined based on the harmonicity of the signal.

15. The method of Embodiment 14 wherein θ_{rev_high} and θ_{rev_low} are determined by:
responsive to a long-term correlation sum, CMS_{LT}, being above or equal to a second predetermined threshold of the harmonic threshold, θₕₐᵣₘ, setting (1201) θ_{rev_high} to θ_{rev1_high} and θ_{rev_low} to θ_{rev1_low}; and
responsive to the long-term correlation sum, CMS_{LT}, being below the second predetermined threshold, setting (1203) θ_{rev_high} to θ_{rev2_high} and θ_{rev_low} to θ_{rev2_low}.

16. The method of Embodiment 15, wherein the second predetermined threshold comprises 60%.

17. An encoder (202, 1802) comprising:
processing circuitry (1502); and
memory (1510) coupled with the processing circuitry, wherein the memory includes instructions that when executed by the processing circuitry causes the encoder (202, Q1802) to perform operations comprising:
   while encoding the input signal in frames using a frequency-domain, FD, coding scheme or time-domain, TD, coding scheme, detecting (601) one or more of a transient attack and a transient release in an input signal and a location of the one or more of the transient attack and the transient release in at least one of a current frame and a previous frame;
   determining (603) whether or not to force a TD coding scheme to be used based on a plurality of conditions associated with the one or more of the transient attack and the transient release; and
   responsive to determining to force the TD coding scheme, switching (605) to the TD coding scheme to encode the one or more of the transient attack and the transient release.

18. An encoder (202, 1802) according to Embodiment 17 wherein the memory includes further instructions that when executed by the processing circuitry causes the encoder (202, 1802) to perform operations according to any of Embodiments 2-16.

19. An encoder (202, 1802) adapted to perform operations comprising:
while encoding the input signal in frames using a frequency-domain, FD, coding scheme or time-domain, TD, coding scheme, detecting (601) one or more of a transient attack and a transient release in an input signal and a location of the one or more of the transient attack and the transient release in at least one of a current frame and a previous frame;
determining (603) whether or not to force a TD coding scheme to be used based on a plurality of conditions associated with the one or more of the transient attack and the transient release; and
responsive to determining to force the TD coding scheme, switching (605) to the TD coding scheme to encode the one or more of the transient attack and the transient release.

20. The encoder (202, 1802) of Embodiment 17 further adapted to perform according to any of Embodiments 2-16.

21. A computer program comprising program code to be executed by processing circuitry (1502) of an encoder (202, 1802), whereby execution of the program code causes the encoder (202, 1802) to perform operations comprising:
while encoding the input signal in frames using a frequency-domain, FD, coding scheme or time-domain, TD, coding scheme, detecting (601) one or more of a transient attack and a transient release in an input signal and a location of the one or more of the transient attack and the transient release in at least one of a current frame and a previous frame;
determining (603) whether or not to force a TD coding scheme to be used based on a plurality of conditions associated with the one or more of the transient attack and the transient release; and
responsive to determining to force the TD coding scheme, switching (605) to the TD coding scheme to encode the one or more of the transient attack and the transient release.

22. The computer program of Embodiment 21, comprising further program code, whereby execution of the further program code causes the encoder (202, 1802) to perform operations according to any of Embodiments 2-16.

23. A computer program product comprising a non-transitory storage medium including program code to be executed by processing circuitry (1502) of an encoder (202, 1802), whereby execution of the program code causes the encoder (202, 1802) to perform operations comprising:
while encoding the input signal in frames using a frequency-domain, FD, coding scheme or time-domain, TD, coding scheme, detecting (601) one or more of a transient attack and a transient release in an input signal and a location of the one or more of the transient attack and the transient release in at least one of a current frame and a previous frame;
determining (603) whether or not to force a TD coding scheme to be used based on a plurality of conditions associated with the one or more of the transient attack and the transient release; and
responsive to determining to force the TD coding scheme, switching (605) to the TD coding scheme to encode the one or more of the transient attack and the transient release.

24. The computer program of Embodiment 23, wherein the non-transitory storage medium comprises further program code, whereby execution of the further program code causes the encoder (202, 1802) to perform operations according to any of Embodiments 2-16.

1. A method in an encoder to adjust a coding scheme selection when detecting a transient in an input sound signal, the encoder encoding the input signal in frames using a frequency-domain, FD, coding scheme or time-domain, TD, coding scheme, the method comprising:
detecting one or more of a transient attack and a transient release in the input signal and a location of the one or more of the transient attack and the transient release in at least one of a current frame and a previous frame;
determining whether or not to force a TD coding scheme to be used based on a plurality of conditions associated with the one or more of the transient attack and the transient release; and
responsive to determining that the TD coding scheme is forced to be used, selecting (605) the TD coding scheme.

2. The method of claim 1, further comprising:
responsive to determining that the TD coding scheme is not forced to be used, determining the coding scheme by a speech/music classifier.

3. The method of claim 1, wherein the plurality of conditions comprises at least two primary conditions.

4. The method of claim 3, wherein a first primary condition of the at least two primary conditions comprises determining whether the transform block of a FD coding scheme contains one or more of the transient attack and the transient release.

5. The method of claim 4 wherein determining whether the transform block of a FD coding scheme contains one or more of the transient attack and the transient release comprises:
determining a first condition, c₁, comprising determining whether the transient or attack is detected in the current frame; and
determining a second condition, c₂, comprising determining whether the transient or attack was detected in a last half of the previous frame.

6. The method of claim 5, wherein determining whether the transient or attack is detected in the current frame comprises determining whether the transient or attack is detected in the current frame excluding a last subframe.

7. The method of claim 3, wherein a second primary condition of the at least two primary conditions comprises determining whether the signal is harmonic.

8. The method of claim 7 wherein determining whether the signal is harmonic comprises determining a third condition, c₃, comprising indicating whether the signal is harmonic.

9. The method of claim 8, wherein determining whether or not to force the TD coding scheme to be used comprises determining to force the TD coding scheme responsive to c₁ or c₂ being fulfilled and c₃ indicating the signal is not harmonic.

10. The method of claim 7, wherein determining whether the signal is harmonic comprises analyzing a long-term evolution of energy spectral peaks across frames by:
computing log bin energy spectra of a signal of the current frame and a signal of the previous frame;
subtracting, from the log bin energy spectra, an estimated noise floor and computing a correlation between the current frame and the previous frame in a band centered around each peak to obtain a correlation map;
summing correlation map values and lowpass filtering the correlation map values sum over frames;
if a long-term correlation map sum, CMS_{LT}, is above a predetermined threshold, θₕₐᵣₘ, classifying the signal as harmonic and setting a harmonicity flag indicating the signal is harmonic; and
updating θₕₐᵣₘ.

11. The method of claim 10, further comprising:
responsive to the harmonicity flag being set, determining that the TD coding scheme is not forced to be used; and
responsive to the harmonicity flag not being set, performing transient analysis to determine whether to force the selection of a TD coding scheme, taking into consideration the location and strength of the one or more of the transient attack and the transient release.

12. The method of claim 1, wherein detecting the one or more of the transient attack and the transient release in the input signal in at least one of the current frame and the previous frame further comprises:
dividing the at least one of the current frame and the previous frame into a plurality of subframes denoted as Sᵢ[j], where j is a j^{th} sample in an i^{th} subframe;
for each subframe, computing an energy of the subframe,
$${E}_{i} = {\sum }_{j = 0}^{k - 1} {{S}_{i} [ j ]}^{2} ,$$
where k is a number of samples in the subframe;
computing a filtered max energy envelope for each subframe, accEᵢ; and
detecting if there is one or more of the transient attack and the transient release in a main part of a windowed signal by checking if the subframe energy is substantially above accE by a threshold θ_{fwd}.

13. The method of claim 12, wherein the threshold θ_{fwd} is dependent on the harmonicity of the signal where θ_{fwd} is set to θ_{fwd1} if the long-term correlation map sum, CMS_{LT}, is above or equal to a predetermined setpoint of the harmonic threshold θₕₐᵣₘ, otherwise θ_{fwd} is set to θ_{fwd2}.

14. The method of claim 12 wherein the predetermined setpoint comprises 80%.

15. The method of claim 12, wherein detecting the one or more of the transient attack and the transient release in the input signal further comprises detecting a transient release by using the transient detector in a reversed time direction using thresholds θ_{rev_high}, θ_{rev_low}, where θ_{rev_high} and θ_{rev_low} are determined based on the harmonicity of the signal.

16. The method of claim 15 wherein θ_{rev_high} and θ_{rev_low} are determined by:
responsive to a long-term correlation sum, CMS_{LT}, being above or equal to a second predetermined setpoint of the harmonic threshold, θₕₐᵣₘ, setting θ_{rev_high} to θ_{rev1_high} and θ_{rev_low} to θ_{rev1_low}; and
responsive to the long-term correlation sum, CMS_{LT}, being below the second predetermined setpoint, setting θ_{rev_high} to θ_{rev2_high} and θ_{rev_low} to θ_{rev2_low}.

17. The method of claim 16, wherein the second predetermined setpoint comprises 60%.

18. (canceled)

19. An encoder comprising:
processing circuitry; and
memory coupled with the processing circuitry, wherein the memory includes instructions that when executed by the processing circuitry causes the encoder to perform operations comprising:
while encoding an input signal in frames using a frequency-domain, FD, coding scheme or time-domain, TD, coding scheme, detecting one or more of a transient attack and a transient release in the input signal and a location of the one or more of the transient attack and the transient release in at least one of a current frame and a previous frame;
determining whether or not to force a TD coding scheme to be used based on a plurality of conditions associated with the one or more of the transient attack and the transient release; and
responsive to determining that the TD coding scheme is forced to be used, selecting the TD coding scheme.

20.-24. (canceled)

25. A computer program product comprising a non-transitory storage medium including program code to be executed by processing circuitry of an encoder, whereby execution of the program code causes the encoder to perform operations comprising:
while encoding an input signal in frames using a frequency-domain, FD, coding scheme or time-domain, TD, coding scheme, detecting one or more of a transient attack and a transient release in the input signal and a location of the one or more of the transient attack and the transient release in at least one of a current frame and a previous frame;
determining whether or not to force a TD coding scheme to be used based on a plurality of conditions associated with the one or more of the transient attack and the transient release; and
responsive to determining that the TD coding scheme is forced to be used, selecting the TD coding scheme.

26. (canceled)
